(19) United States
(12) Patent Application Publication
(10) Pub. No.: US 2026/0362542 A1
(43) Pub. Date: Nov. 12, 2026

(54) eDRX BASED INTER-RAT NR MEASUREMENT ENHANCEMENT WITH CCA

(71) Applicant: Apple Inc., Cupertino, CA (US)

(72) Inventors: Jie Cui, San Jose, CA (US); Yang Tang, San Jose, CA (US); Qiming Li, Beijing (CN); Dawei Zhang, Saratoga, CA (US); Haitong Sun, Cupertino, CA (US); Hong He, San Jose, CA (US)

(21) Appl. No.: 19/472,609

(22) PCT Filed: Apr. 6, 2023
(86) PCT No.: PCT/CN2023/086618

§ 371 Date: Oct. 3, 2025

(51) Int. Cl. H04W 76/28; H04L 5/00; H04W 74/0816

(52) U.S. Cl. CPC H04W 76/28; H04L 5/0098; H04W 74/0816

(57) ABSTRACT

A user equipment (UE) including a transceiver operable in an extended discontinuous reception (eDRX) mode with respect to a long-term evolution (LTE) network, and a processor configured to: receive multiple samples in a paging time window (PTW) to perform inter-radio access technology (inter-RAT) measurements associated with clear channel assessment (CCA) for a carrier or a cell; determine that the inter-RAT measurements associated with the CCA for the carrier or the cell are not performed on a particular number of samples of the received multiple samples; and in response to the determining, identify a required extension of time for performing the inter-RAT measurements. The processor is configured to restart the inter-RAT measurements associated with the CCA in response to the required extension of time for performing the inter-RAT measurements causing the inter-RAT measurements to be performed beyond a maximum time duration limit for a single PTW.

### TECHNICAL FIELD

This application relates generally to wireless communication systems, including methods and implementations of performing inter-radio access technology (inter-RAT) measurements by a user equipment (UE) operating in an extended discontinuous reception (eDRX) mode with clear channel assessment (CCA).

### BACKGROUND

Wireless mobile communication technology uses various standards and protocols to transmit data between a network device (e.g., a base station, a network access point, or a relay) and a wireless communication device (e.g., a user equipment (UE)). Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device (e.g., a base station, a network access point, or a relay) of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device (e.g., a base station, a network access point, or a relay) used by a RAN may correspond to that RAN. One example of the network device may be an E-UTRAN base station, which is an Evolved Universal Terrestrial Radio Access Network (E-UTRAN) Node B (also commonly denoted as evolved Node B, enhanced Node B, eNodeB, or eNB). Another example of the network device may be an NG-RAN base station, which is a next generation Node B (also sometimes referred to as a gNode B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 shows a communication system including multiple user equipments (UEs) in communication with multiple network devices (e.g., transmission and reception points (TRPs)).

FIG. 2 shows an example diagram of extending a time window to perform inter-RAT measurements, in accordance with some embodiments.

FIG. 3 shows an example method performed by a UE for performing inter-RAT measurements, in accordance with some embodiments.

FIG. 4 shows an example method performed by a network device for the UE to perform inter-RAT measurements, in accordance with some embodiments.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a network device and/or a user equipment (UE). However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device. Similarly, various embodiments are described with regard to a network device, which may be a network access point, a base station, and/or a relay deployed in a terrestrial network (TN), a satellite, and/or a high-altitude platform system (HAPS) including manned or unmanned aerial vehicles, and so on.

Various embodiments described herein correspond to a UE operating in a long-term evolution (LTE) network and performing inter-radio access technology (inter-RAT) measurement with respect to a target cell, which for example may be operating on an unlicensed carrier such as in a Wi-Fi frequency range (or band). The UE accordingly may need to perform a clear channel assessment (CCA) procedure before transmitting in order to avoid collision with another UE (or an unlicensed device, such as a Wi-Fi device) transmitting over the same resource at the same time. The inter-RAT measurements, as described herein, may correspond to measurements performed for a cell detection, a cell evaluation, and/or a cell measurement on measurement samples (or samples) received during a paging time window (PTW). However, if there is a CCA failure during the PTW due to another UE transmitting or receiving using the same resource at the time the UE is to receive a sample for performing inter-RAT measurement, the UE may not receive a sample, and the UE cannot perform the inter-RAT measurement. Since for each of the cell detection, cell evaluation, and/or cell measurement related inter-RAT measurements, the UE needs to perform measurement on a specific number of samples, the UE may need to restart the inter-RAT measurement in a next available PTW as defined in 3GPP TS36.133, which may introduce delay. Alternatively, after two unsuccessful measurement attempts due to exceeding a maximum number of a synchronization signal block based measurement timing configuration (SMTC) occasions being unavailable at the UE, the UE may need to detect a cell on a configured serving or non-serving carrier. Various embodiments described herein may improve inter-RAT measurement in this situation by extending a PTW beyond a maximum time duration limit for the PTW.

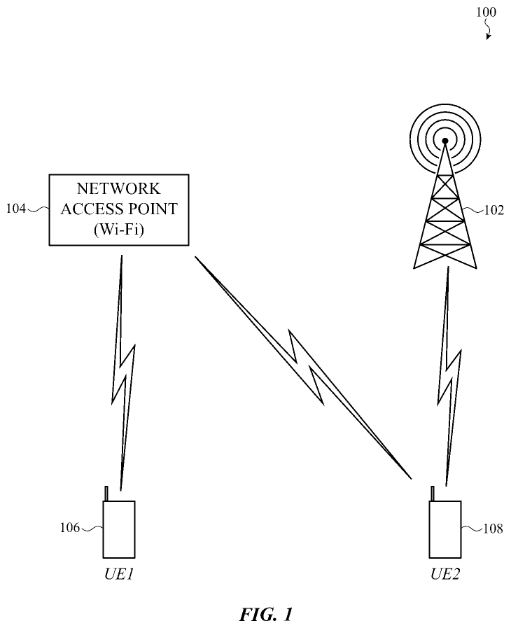

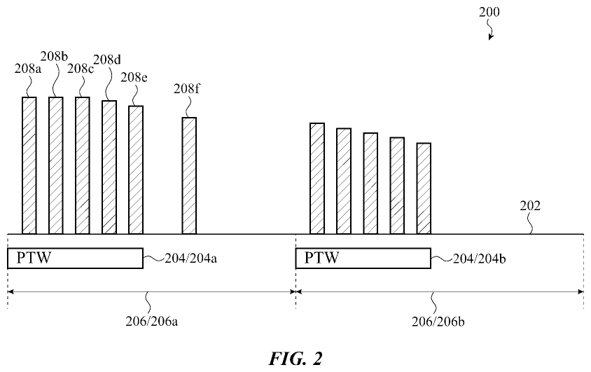

FIG. 1 shows a communication system 100 including a UE1 106 and a UE2 108 in communication with network devices 102 and 104. The network devices 102 and/or 104 may be a base station, a network access point, a Wi-Fi access point, or a relay. The network devices 102 and/or 104 may communicate in an uplink (UL) direction and/or in a downlink (DL) direction with the UE1 106 and the UE2 108. The UE1 106 and the UE2 108 each need to perform CCA procedure before UL communication with the network device 104 operating in a non-licensed carrier frequency range (or band). If there is a CCA failure for a UE, the UE may not perform UL and/or DL communication or perform inter-RAT measurement as shown in FIG. 2 and described below.

FIG. 2 shows an example diagram of extending a time window to perform inter-RAT measurements, in accordance with some embodiments. As shown in a diagram 200 of FIG. 2, multiple PTWs 204a and 204b (or 204) are shown. A PTW may repeat at a PTW periodicity 206 shown as 206a and/or 206b. The PTW periodicity may also be referenced herein as an extended discontinuous reception (eDRX) cycle. During the PTW 204, multiple samples, for example, samples 208a-208e may be received by the UE. The UE may perform inter-RAT measurements on the received samples 208a-208e. Though only five samples are shown in FIG. 2, a number of samples received during the PTW 204 may be more or less than five samples.

Additionally, or alternatively, the received samples may be divided or grouped into different subsets of samples to perform inter-RAT measurements corresponding to each of cell detection, cell evaluation, and/or cell measurement. Accordingly, if a particular inter-RAT measurement, e.g., cell detection, cell evaluation, and/or cell measurement, fails due to not receiving a sample (e.g., the sample 208c) to perform a respective cell detection, cell evaluation, and/or cell measurement, the UE may need to restart inter-RAT measurement on samples received during a next available PTW 204b. Alternatively, the UE may perform the respective cell detection, cell evaluation, and/or cell measurement on a sample 208f received outside of the PTW 204a. In other words, the respective cell detection, cell evaluation, and/or cell measurement may be performed on the sample 208f received in an extended PTW (e.g., beyond a maximum time duration limit of a single PTW). Additionally, or alternatively, the sample 208f that is an additional sample may be received within the maximum time duration limit of the single PTW. The UE may be configured or dynamically instructed to extend the PTW to perform the inter-RAT measurement under the conditions described herein.

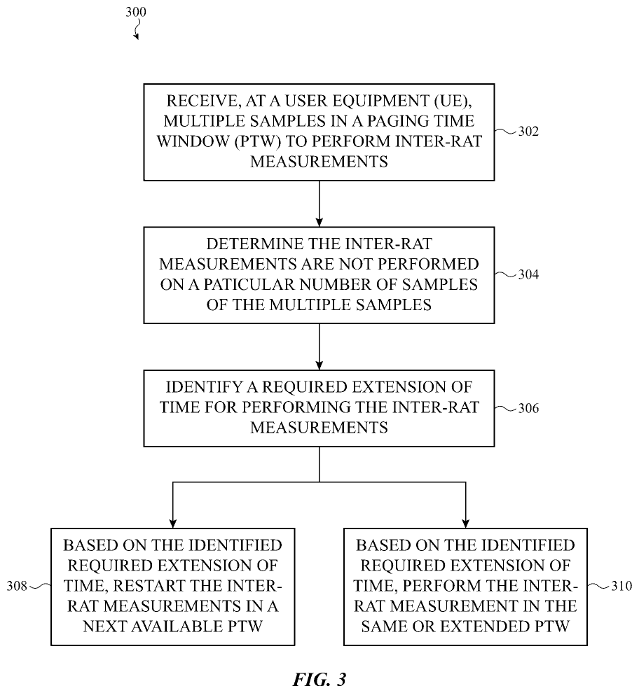

FIG. 3 shows an example method performed by a UE for performing inter-RAT measurements, in accordance with some embodiments. As shown in a flow-chart 300, a UE operable in an eDRX mode with respect to an LTE network may receive multiple samples in a PTW to perform inter-RAT measurements associated with CCA for a carrier or a cell, which is shown in the flow-chart 300 at 302. As described herein, the inter-RAT measurements may include measurements corresponding to cell evaluation, a cell detection, and/or a cell measurement.

The multiple samples received at 302 may be grouped in different subsets, for example, a first subset of the multiple samples received during a cell detection window of the PTW to perform cell detection measurements, a second subset of the multiple samples received during a cell evaluation window of the PTW to perform cell evaluation measurements, and a third subset of the multiples received during a cell measurement window of the PTW to perform cell measurements. A count of samples in each the first subset of the multiple samples, the second subset of the multiple samples, and the third subset of the multiple samples may be same or different from each other. Similarly, a respective size of the cell detection window, the cell evaluation window, and/or the cell measurement window may be same or different from each other.

At 304, the UE may determine that the inter-RAT measurements for the carrier or the cell are not performed on a particular number of samples of the multiple samples received at 302 due to CCA failure. As described herein, due to CCA failure, the UE may not receive a particular sample to perform a respective inter-RAT measurement.

At 306, in response to determining that the inter-RAT measurements for the carrier or the cell are not performed on the particular number of samples of the multiple samples, the UE may identify a required extension of time for performing the inter-RAT measurements. By way of a non-limiting example, the required extension of time may be determined by the UE based on a specific guidance from a network device, or may be determined by the network device.

In some embodiments, the required extension of time for performing the inter-RAT measurements corresponding to a cell evaluation measurement may be determined based on a minimum (min) of (M_{e,max}, Z−Xₑ), where Me, max corresponds with a maximum window extension size for the cell evaluation measurement, Z corresponds with the size of the single PTW, and Xₑ corresponds with a legacy window size for the cell evaluation measurement. Similarly, the required extension of time for performing the inter-RAT measurements corresponding to a cell detection measurement may be determined based on a min of (M_{d,max}, Z−X_{d}), and the required extension of time for performing the inter-RAT measurements corresponding to a cell measurement may be determined based on a min of (M_{m,max}, Z−Xₘ), where M_{d,max} corresponds with a maximum window extension size for the cell detection measurement, X_{d} corresponds with a legacy window size for the cell detection measurement, M_{m,max} corresponds with a maximum window extension size for the cell measurement, and Xₘ corresponds with a legacy window size for the cell measurement.

Accordingly, in some embodiments, the cell evaluation window, the cell detection window, and/or the cell measurement window may be extended in such a way that an extension in accordance with required extension of time as described herein is limited to a maximum time duration limit of a single PTW, which is shown in FIG. 3 as 310. In other words, any extension of time required to receive an additional sample and to perform the respective inter-RAT measurement does not cause any extension of the PTW, and if any extension of time required to receive an additional sample causes an extension of the PTW, then the inter-RAT measurements may be restarted or performed in a next available PTW window, which is shown in FIG. 3 as 308.

Alternatively, in some embodiments, the cell evaluation window, the cell detection window, and/or the cell measurement window may be extended in such a way that an additional sample may be received and the respective inter-RAT measurement may be performed beyond the maximum time duration limit of the PTW if an extension corresponding to a cell detection measurement does not exceed the M_{d,max}, an extension corresponding to a cell evaluation measurement does not exceed the M_{e,max}, and/or an extension corresponding a cell measurement does not exceed the M_{m,max}. However, if the extension corresponding to the cell detection measurement exceeds the M_{d,max}, the extension corresponding to the cell evaluation measurement exceeds the M_{e,max}, and/or the extension corresponding the cell measurement exceeds the M_{m,max}, then the inter-RAT measurements may be restarted or performed in a next available PTW window.

Alternatively, in some embodiments, the cell evaluation window, the cell detection window, and/or the cell measurement window may be extended in such a way that an additional sample may be received and the respective inter-RAT measurement may be performed beyond the maximum time duration limit of the PTW, which PTW is extended by a particular factor (P). By way of a non-limiting example, the particular factor P may be a fixed factor configured at the UE by a network (e.g., a radio access network (RAN) or a core network (CN)) or a predetermined fixed factor. The required extension of time for performing the inter-RAT measurements corresponding to a cell evaluation measurement may be determined based on a minimum (min) of (M_{e,max}, Z+P−Xₑ). Similarly, the required extension of time for performing the inter-RAT measurements corresponding to a cell detection measurement may be determined based on a min of (M_{d,max}, Z+P−X_{d}), and the required extension of time for performing the inter-RAT measurements corresponding to a cell measurement may be determined based on a min of (M_{m,max}, Z+P−Xₘ). However, any extension required beyond the determined extension as described herein may cause the UE to restart or perform the inter-RAT measurements in a next available PTW window.

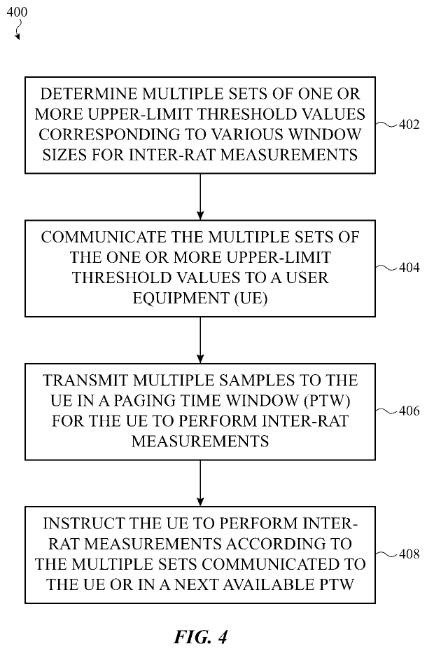

FIG. 4 shows an example method performed by a network device for the UE to perform inter-RAT measurements, in accordance with some embodiments. As shown in a flow-chart 400, at 402, a network device may determine a first and a second sets of one or more upper-limit threshold values corresponding to a maximum window extension size for a cell evaluation measurement (M_{e,max}), a maximum window extension size for a cell detection measurement (M_{d,max}), and a maximum window extension size for a cell measurement (M_{m,max}). By way of a non-limiting example, the first set may correspond to the eDRX mode, and the second set may correspond to discontinuous reception (DRX) mode of operations of the UE.

At 404, the network device may communicate the first and the second sets of one or more upper-limit threshold values to the UE. At 406, the network device may transmit multiple samples in a paging time window (PTW) to the UE to perform inter-radio access technology (inter-RAT) measurements associated with CCA for a carrier or a cell, and also instruct the UE to restart the inter-RAT measurements associated with the CCA or perform the inter-RAT measurements associated with the CCA in accordance with the transmitted first and second sets of one or more upper-limit threshold values in response to the inter-RAT measurements associated with the CCA for the carrier or the cell not performed on a particular number of samples of the transmitted multiple samples shown in the flow-chart 400 as 408.

As described herein, the inter-RAT measurements include measurements corresponding to any of a cell evaluation, a cell detection, and a cell measurement, and the network device may instruct the UE to perform the inter-RAT measurements associated with the CCA within a single PTW, beyond a single PTW, beyond a single PTW extended by the particular factor (P), and/or in a next available PTW.

Embodiments contemplated herein include an apparatus having means to perform one or more elements of the method 300, or 400. In the context of method 300, the apparatus may be, for example, an apparatus of a UE (such as a wireless device 602 that is a UE, as described herein). In the context of method 400, the apparatus may be, for example, an apparatus of a network device (such as a network device 620 that is a network access point or a base station, as described herein).

Embodiments contemplated herein include one or more non-transitory computer-readable media storing instructions to cause an electronic device, upon execution of the instructions by one or more processors of the electronic device, to perform one or more elements of the method 300 or 400. In the context of method 300, the non-transitory computer-readable media may be, for example, a memory of a UE (such as a memory 606 of a wireless device 602 that is a UE, as described herein). In the context of method 400, the non-transitory computer-readable media may be, for example, a memory of a network device (such as a memory 624 of a network device 620 that is a network access point or a base station, as described herein).

Embodiments contemplated herein include an apparatus that has logic, modules, or circuitry to perform one or more elements of the method 300 or 400. In the context of method 300, the apparatus may be, for example, an apparatus of a UE (such as a wireless device 602 that is a UE, as described herein). In the context of method 400, the apparatus may be, for example, an apparatus of a network device (such as a network device 620 that is a network access point or a base station, as described herein).

Embodiments contemplated herein include an apparatus having one or more processors and one or more computer-readable media, using, or storing instructions that, when executed by the one or more processors, cause the one or more processors to perform one or more elements of the method 300 or 400. In the context of method 300, the apparatus may be, for example, an apparatus of a UE (such as a wireless device 602 that is a UE, as described herein). In the context of the method 400, the apparatus may be, for example, an apparatus of a network device (such as a network device 620 that is a network access point or a base station, as described herein).

Embodiments contemplated herein include a signal as described in or related to one or more elements of the method 300 or 400.

Embodiments contemplated herein include a computer program or computer program product that has instructions, wherein execution of the program by a processor causes the processor to carry out one or more elements of the method 300 or 400. In the context of method 300, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). In the context of method 400, the processor may be a processor of a network device (such as a processor(s) 622 of a network device 620 that is a network access point or a base station, as described herein), and the instructions may be, for example, located in the processor and/or on a memory of the network device (such as a memory 624 of a network device 620 that is a network access point or a base station, as described herein).

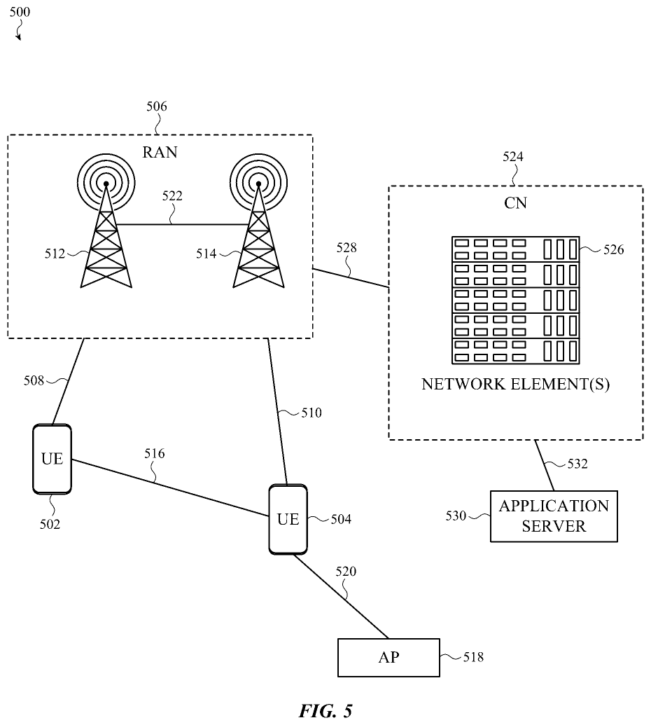

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, and so on. The UE 502 and UE 504 utilize connections (or channels) (shown as connection 508 and connection 510, respectively) with the RAN 506, each of which comprises a physical communications interface. The RAN 506 can include one or more base stations, such as base station 512 and base station 514, that enable the connection 508 and connection 510. In some embodiments, the RAN 506 may include one or more relays.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all, or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an SI interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the SI control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, and so on.) for the UE 502 and UE 504 via the CN 524. The application server 530 may communicate with the CN 524 through an IP communications interface 532.

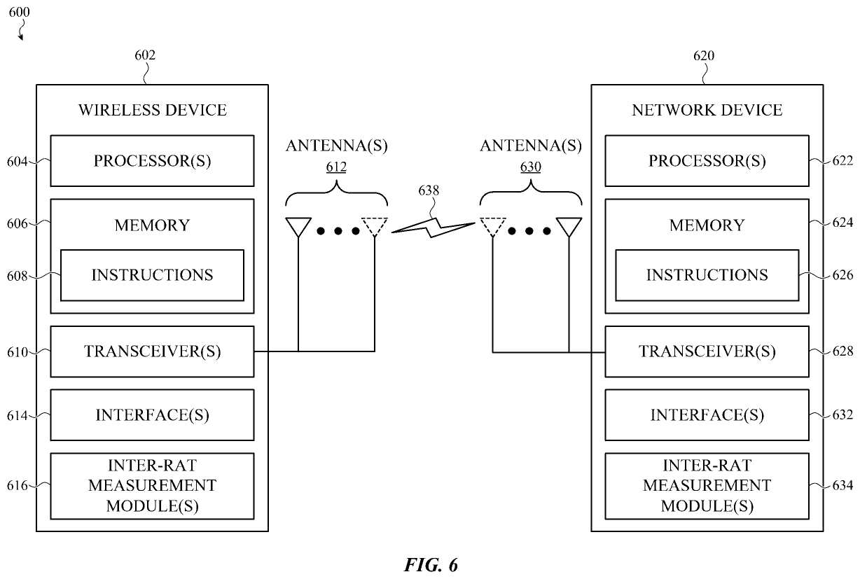

FIG. 6 illustrates a system 600 for performing signaling 638 between a wireless device 602 and a network device 620, according to embodiments disclosed herein. The system 600 may be a portion of a wireless communication system as herein described. The wireless device 602 may be, for example, a UE of a wireless communication system. The network device 620 may be, for example, a base station (e.g., an eNB or a gNB), or a relay of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 640) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments that have multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include one or more inter-RAT measurement module(s) 616. The inter-RAT measurement module(s) 616 may be implemented via hardware, software, or combinations thereof. For example, the inter-RAT measurement module(s) 616 may be implemented as a processor, circuit, and/or instructions 608 stored in the memory 606 and executed by the processor(s) 604. In some examples, the inter-RAT measurement module(s) 616 may be integrated within the processor(s) 604 and/or the transceiver(s) 610. For example, the inter-RAT measurement module(s) 616 may be implemented by a combination of software components (e.g., executed by a DSP or a general processor) and hardware components (e.g., logic gates and circuitry) within the processor(s) 604 or the transceiver(s) 610.

The inter-RAT measurement module(s) 616 may be used for various aspects of the present disclosure, for example, aspects of FIGS. 1-4, from a UE perspective.

The network device 620 may include one or more processor(s) 622. The processor(s) 622 may execute instructions such that various operations of the network device 620 are performed, as described herein. The processor(s) 604 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 638) to and/or from the network device 620 with other devices (e.g., the wireless device 602) according to corresponding RATs.

The network device 620 may include one or more antenna(s) 630 (e.g., one, two, four, or more). In embodiments that have multiple antenna(s) 630, the network device 620 may perform MIMO, digital beamforming, analog beamforming, beam steering, and so on, as has been described.

The network device 620 may include one or more interface(s) 632. The interface(s) 632 may be used to provide input to or output from the network device 620. For example, a network device 620 that is a base station may include interface(s) 632 made up of transmitters, receivers, and other circuitry (e.g., other than the transceiver(s) 628/antenna(s) 630 already described) that enables the base station to communicate with other equipment in a core network, and/or that enables the base station to communicate with external networks, computers, databases, and the like for purposes of operation, administration, and maintenance of the base station or other equipment operably connected thereto.

The network device 620 may include one or more inter-RAT measurement module(s) 634. The inter-RAT measurement module(s)) 634 may be implemented via hardware, software, or combinations thereof. For example, the inter-RAT measurement module(s) 634 may be implemented as a processor, circuit, and/or instructions 626 stored in the memory 624 and executed by the processor(s) 622. In some examples, the inter-RAT measurement module(s) 634 may be integrated within the processor(s) 622 and/or the transceiver(s) 628. For example, the inter-RAT measurement module(s) 634 may be implemented by a combination of software components (e.g., executed by a DSP or a general processor) and hardware components (e.g., logic gates and circuitry) within the processor(s) 622 or the transceiver(s) 628.

The inter-RAT measurement module(s) 634 may be used for various aspects of the present disclosure, for example, aspects of FIGS. 1-4, from a network device perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, and so on. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, and so on. of one embodiment can be used in another embodiment. The parameters, attributes, aspects, and so on. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1-7. (canceled)

8. An apparatus comprising a memory coupled to a processor, the processor configured to:
receive, while operating in an extended discontinuous reception (eDRX) mode with respect to a long-term evolution (LTE) network, multiple samples in a paging time window (PTW) to perform inter-radio access technology (inter-RAT) measurements associated with clear channel assessment (CCA) for a carrier or a cell;
determine that the inter-RAT measurements associated with the CCA for the carrier or the cell are not performed on a particular number of samples of the received multiple samples; and
in response to the determining,
perform the inter-RAT measurements associated with the CCA by extending the time available for the inter-RAT measurements within the PTW up to a maximum time duration limit for a single PTW.

9. The apparatus of claim 8, wherein the inter-RAT measurements include measurements corresponding to any of a cell evaluation, a cell detection, and a cell measurement.

10. The apparatus of claim 8, wherein the processor is further configured to restart the inter-RAT measurements associated with the CCA in a next available PTW in accordance with,
the required extension of time for performing the inter-RAT measurements corresponding to a cell evaluation measurement exceeding M_{e,max} corresponding to a maximum window extension size for the cell evaluation measurement;
the required extension of time for performing the inter-RAT measurements corresponding to a cell detection measurement exceeding M_{d,max} corresponding to a maximum window extension size for the cell detection measurement; or
the required extension of time for performing the inter-RAT measurements corresponding to a cell measurement exceeding M_{m,max} corresponding to a maximum window extension size for the cell measurement.

11. The apparatus of claim 8, wherein the processor is further configured to perform the inter-RAT measurements associated with the CCA beyond a single PTW extended by a particular factor (P).

12. The apparatus of claim 11, wherein the particular factor (P) by which the single PTW is extended is a fixed factor.

13. The apparatus of claim 12, wherein the fixed factor is predetermined or configured by a network.

14. The apparatus of claim 11, wherein:
the required extension of time for performing the inter-RAT measurements corresponding to a cell evaluation measurement is determined based on a minimum (min) of (M_{e,max}, Z+P−Xₑ), M_{e,max} corresponds with a maximum window extension size for the cell evaluation measurement, Z corresponds with the size of the single PTW, and Xₑ corresponds with a legacy window size for the cell evaluation measurement;
the required extension of time for performing the inter-RAT measurements corresponding to a cell detection measurement is determined based on a min of (M_{d,max}, Z+P−X_{d}), M_{d,max} corresponds with a maximum window extension size for the cell detection measurement, Z corresponds with the size of the single PTW, and X_{d} corresponds with a legacy window size for the cell detection measurement; and
the required extension of time for performing the inter-RAT measurements corresponding to a cell measurement is determined based on a min of (M_{m,max}, Z+P−Xₘ), M_{m,max} corresponds with a maximum window extension size for the cell measurement, Z corresponds with the size of the single PTW, and Xₘ corresponds with a legacy window size for the cell measurement.

15. The apparatus of claim 14, wherein the processor is further configured to restart the inter-RAT measurements associated with the CCA in a next available PTW in accordance with,
the required extension of time for performing the inter-RAT measurements corresponding to a cell evaluation measurement exceeding min of (M_{e,max}, Z+P−Xₑ);
the required extension of time for performing the inter-RAT measurements corresponding to a cell detection measurement exceeding min of (M_{d,max}, Z+P−X_{d}); or
the required extension of time for performing the inter-RAT measurements corresponding to a cell measurement exceeding min of (M_{m,max}, Z+P−Xₘ).

16. An apparatus comprising a memory coupled to a processor, the processor configured to:
determine, while operating in an extended discontinuous reception (eDRX) mode with respect to a long-term evolution (LTE) network with a user equipment (UE), a first and a second sets of one or more upper-limit threshold values corresponding to a maximum window extension size for a cell evaluation measurement (M_{e,max}), a maximum window extension size for a cell detection measurement (M_{d,max}), and a maximum window extension size for a cell measurement (M_{m,max}), the first set corresponds to the eDRX and the second set corresponds to discontinuous reception (DRX);
communicate the first and the second sets of one or more upper-limit threshold values to the UE;
transmit multiple samples in a paging time window (PTW) to the UE to perform inter-radio access technology (inter-RAT) measurements associated with clear channel assessment (CCA) for a carrier or a cell; and
instruct the UE to restart the inter-RAT measurements associated with the CCA or perform the inter-RAT measurements associated with the CCA in accordance with the transmitted first and second sets of one or more upper-limit threshold values in response to the inter-RAT measurements associated with the CCA for the carrier or the cell not performed on a particular number of samples of the transmitted multiple samples.

17. The apparatus of claim 16, wherein the inter-RAT measurements include measurements corresponding to any of a cell evaluation, a cell detection, and a cell measurement.

18. The apparatus of claim 16, wherein the processor is configured to instruct the UE to perform the inter-RAT measurements associated with the CCA within a single PTW.

19. The apparatus of claim 16, wherein the processor is configured to instruct the UE to perform the inter-RAT measurements associated with the CCA beyond a single PTW.

20. The apparatus of claim 16, wherein the processor is configured to instruct the UE to perform the inter-RAT measurements associated with the CCA beyond a single PTW extended by a particular factor (P), the particular factor (P) is a predetermined fixed factor, or a fixed factor configured by a network.

21. An apparatus comprising a memory coupled to a processor, the processor configured to:
receive, while operating in an extended discontinuous reception (eDRX) mode with respect to a long-term evolution (LTE) network, multiple samples in a paging time window (PTW) to perform inter-radio access technology (inter-RAT) measurements associated with clear channel assessment (CCA) for a carrier or a cell;
determine that the inter-RAT measurements associated with the CCA for the carrier or the cell are not performed on a particular number of samples of the received multiple samples;
in response to the determining, identify a required extension of time for performing the inter-RAT measurements; and
in response to the required extension of time for performing the inter-RAT measurements causing the inter-RAT measurements to be performed beyond a maximum time duration limit for a single PTW, restart the inter-RAT measurements associated with the CCA, or
in response to the required extension of time for performing the inter-RAT measurements being performed within the maximum time duration limit for the single PTW, perform the inter-RAT measurements associated with the CCA within a time extension of the single PTW, the time extension corresponding to the identified required extension of time.

22. The apparatus of claim 21, wherein the inter-RAT measurements include measurements corresponding to any of a cell evaluation, a cell detection, and a cell measurement.

23. The apparatus of claim 21, wherein the processor is further configured to:
perform the inter-RAT measurements corresponding to a cell evaluation on a first subset of the multiple samples received in a cell evaluation window of the PTW;
perform the inter-RAT measurements corresponding to a cell detection on a second subset of the multiple samples received in a cell detection window of the PTW; and
perform the inter-RAT measurements corresponding to a cell measurement on a third subset of the multiple samples received in a cell measurement window of the PTW.

24. The apparatus of claim 23, wherein:
a count of samples in the first subset of the multiple samples is different from a count of samples in the second subset or the third subset of the multiple samples; and
the count of samples in the second subset of the multiple samples is different from the count of samples in the third subset of the multiple samples.

25. The apparatus of claim 23, wherein:
a size of the cell evaluation window is different from a size of the cell detection window or a size of the cell measurement window; and
the size of the cell detection window is different from the size of the cell measurement window.

26. The apparatus of claim 21, wherein:
the required extension of time for performing the inter-RAT measurements corresponding to a cell evaluation measurement is determined based on a minimum (min) of (M_{e,max}, Z−Xₑ), M_{e,max} corresponds with a maximum window extension size for the cell evaluation measurement, Z corresponds with the size of the single PTW, and Xₑ corresponds with a legacy window size for the cell evaluation measurement;
the required extension of time for performing the inter-RAT measurements corresponding to a cell detection measurement is determined based on a min of (M_{d,max}, Z−X_{d}), M_{d,max} corresponds with a maximum window extension size for the cell detection measurement, and X_{d} corresponds with a legacy window size for the cell detection measurement; and
the required extension of time for performing the inter-RAT measurements corresponding to a cell measurement is determined based on a min of (M_{m,max}, Z−Xₘ), M_{m,max} corresponds with a maximum window extension size for the cell measurement, and Xₘ corresponds with a legacy window size for the cell measurement.

27. The apparatus of claim 21, wherein to restart the inter-RAT measurements associated with the CCA, the processor is further configured to perform the inter-RAT measurements in a next available PTW.
